(19) United States
(12) Patent Application Publication
(10) Pub. No.: US 2004/0173143 A1
(43) Pub. Date: Sep. 9, 2004

(54) Erasable ink delivery devices, stamp pads, stencil sets and methods and kits related thereto

(76) Inventor: James D. King, Salt Lake City, UT (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/671,429

(22) Filed: Sep. 24, 2003

Related U.S. Application Data
(60) Provisional application No. 60/413,716, filed on Sep. 25, 2002.
(60) Provisional application No. 60/461,203, filed on Apr. 7, 2003.

(51) Int. Cl. B05C 11/00

(52) U.S. Cl. 118/264; 118/265

(57) ABSTRACT

Erasable-ink delivery and usage devices, methods, and the like, including rubber stamp pads, spray bottles (aerosol, pump and otherwise), and stencil sets. The erasable ink can be wet or dry-erasable-ink. The ink from the stamp pad, etc., can be erased from a suitable surface, such as a dry erase board, and can be used in any desirable situation.

### CROSS-REFERENCE TO RELATED APPLICATIONS

The present application claims priority from U.S. provisional patent application No. 60/413,716, filed Sep. 25, 2002, and from U.S. provisional patent application No. 60/461,203, filed Apr. 7, 2003, both of which are presently pending. These and all other references cited herein are incorporated herein by reference in their entirety.

### BACKGROUND

Erasable inks are well known and used for a wide variety of fun and useful purposes but are typically restricted to writing via felt-tip marker type pens (the actual carrier can be materials other than felt if desired felt). Stamp pads and rubber stamps are also well known and used for a wide variety of fun and useful purposes including date-stamping documents and creating artistic impressions. The focus of such stamps has been to create a permanent design or impression on a surface or substrate. However, with the introduction of personal goal tracking systems requiring some nonpermanent markings, U.S. Provisional Patent Application No. 60/413,716, and the realization of other usages in which a variety of erasable ink-delivery systems could be useful, there has developed a need for erasable ink delivery devices, systems, methods and the like, such as stamp pads, beyond the traditional felt-tip marker pen.

The present invention provides solutions to this need, and other advantages.

### SUMMARY

The present invention comprises erasable-ink delivery and usage devices, systems, kits, methods, etc., such as rubber stamp pads, spray bottles (aerosol, pump and otherwise), and stencil sets. One example of this is rubber stamp pads, stamp pad systems, kits, methods, etc., comprising erasable-ink in the stamp pad. The erasable ink can be wet or dry-erasable-ink. The erasable ink from the delivery device can be applied to and erased from any suitable surface, such as glass or a dry erase board. One example of the use of such a system is with goal tracking systems discussed herein. The erasable-ink stamp pads and other delivery and usage systems can, however, be used in any desirable situation, for example on business advertising boards to replace advertising chalk boards, on storefront windows, in business meetings, at schools, or in any other situation in which erasable-inks delivered via delivery devices other than marker pens would be helpful.

In other aspects, the systems, etc., comprise stencil kits comprising a stencil and an erasable ink delivery device. If desired, the kits can further comprise an erasable-ink eraser configured to remove the erasable ink from a surface and an easily-erasable substrate. The eraser can be attached to at least one of the stencil and the substrate, for example by a tether, or the eraser can be not attached to either the stencil or the substrate. The erasable ink can be a dry erase ink or other erasable ink, and the erasable ink delivery device can be an ink-spray container such as a an aerosol can or a pump spray bottle configured to emit the erasable ink as a spray. The kits can further comprise a refill bottle configured for re-filling the ink-spray container.

Other embodiments comprise an ink-spray container containing the erasable ink and configured to emit the erasable ink as a spray, as discussed elsewhere herein.

Further embodiments comprise making stencil kits comprising placing in a single container a stencil and an erasable ink delivery device, and if desired an erasable-ink eraser and easily-erasable substrate. The erasable ink delivery device can be an ink-spray container. Additional methods comprise making an erasable ink symbol comprising applying the erasable ink through a stencil comprising the symbol onto an easily erasable substrate. The erasable ink can be applied by spraying the ink from an aerosol can or pump spray bottle, by brushing or stamping, or otherwise as desired. The methods also comprise making an erasable ink symbol, with or without a stencil, by spraying, brushing, or stamping the erasable ink onto an easily erasable substrate. The methods can further comprise erasing the symbol.

In one aspect, the present invention provides a stamp pad kit comprising: a stamp pad sized and configured to provide ink to a rubber stamp, the stamp pad comprising a base and an ink-containing pad containing substantially only erasable ink, a lid sized to cover the ink-containing pad; and an erasable-ink eraser configured to remove the erasable ink from a surface. In this and other aspects (unless expressly stated otherwise or clear from the context, all embodiments, aspects, features, etc., can be mixed and matched, combined and permuted in any desired manner). The eraser can be attached to at least one of the base and the lid, adhered directly to a top surface of the lid, linked by a tether to at least one of the base and the lid, or it not be attached to either the base or the lid.

The ink-containing pad can be disposed next to a second ink-containing pad on the base, which second pad can comprise erasable or non-erasable (substantially permanent) ink. The erasable ink can be a dry erase ink. The kit can, if desired, comprise at least one rubber stamp sized for use with the ink-containing pad, a refill bottle configured for re-filling the ink-containing pad and containing erasable ink. The kit further can also comprise an easily-erasable substrate such as a dry erase board, and the pad can be a self-inking stamp pad.

In another aspect, the present invention also provides a self-inking rubber stamp wherein the improvement can comprise the stamp pad comprising substantially only erasable ink. The self-inking rubber stamp can also comprise an erasable-ink eraser configured to remove the erasable ink from a surface. The present invention also provides a base for a stamp pad sized and configured to provide ink to a rubber stamp, the base holding an ink-containing pad containing substantially only erasable ink disposed on the base and attached to an erasable-ink eraser configured to remove the erasable ink from a surface. The eraser can be adhered directly to at least one of a side surface and a bottom surface of the base or otherwise as desired, or the eraser can be linked by a tether to the base. The ink-containing pad can be disposed next to a second ink-containing pad on the base and the erasable ink can be a dry erase ink. The present invention further provides a lid for a stamp pad, the lid sized to cover an ink-containing pad on the stamp pad and the lid attached to an erasable-ink eraser configured to remove the erasable ink from a surface.

In other aspects, the present invention provides methods of making a stamp pad sized and configured to provide ink to a rubber stamp, the methods comprising providing a stamp pad comprising a base and a lid, and attaching an ink-containing pad containing substantially only erasable ink to the base. The methods further can comprise attaching to at least one of the base and the lid an erasable-ink eraser configured to remove the erasable ink from a surface. The methods can also comprise adhering the erasable-ink eraser directly to the at least one of the base and the lid, or via a tether. The ink-containing pad can be disposed next to a second ink-containing pad on the base, and the erasable ink can be a dry erase ink.

In still other aspects, the present invention provides methods of making a stamp pad kit comprising: placing in a single container a stamp pad sized and configured to provide ink to a rubber stamp, the stamp pad comprising a base and an ink-containing pad containing substantially only erasable ink, a lid sized to cover the ink-containing pad and an erasable-ink eraser configured to remove the erasable ink from a surface. The methods further can comprise adhering the erasable-ink eraser to the base or lid, or keeping the different components non-attached.

The methods also can comprise placing in or providing with the container a refill bottle configured for re-filling the ink-containing pad and containing erasable ink, at least one easily-erasable substrate, and at least one rubber stamp sized for use with the ink-containing pad. The at least one rubber stamp can be a self-inking rubber stamp.

The methods also can comprise stamping comprising: applying a rubber stamp inked with an erasable ink to a surface to transfer the erasable ink from the rubber stamp to the surface; and, erasing the erasable ink from the surface with an erasable-ink eraser. Such methods can additionally comprise, before applying the rubber stamp to the surface, inking the rubber stamp by applying the rubber stamp to an ink-containing pad containing substantially only erasable ink such that the erasable ink can be transferred from the ink-containing pad to the rubber stamp. The methods can be performed using a self-inking rubber stamp.

The eraser can be adhered directly to at least one of the lid and the base and the methods further can comprise grasping the at least one of the lid and the base and during erasing applying force to the eraser through the at least one of the lid and the base, or the eraser can be linked by a tether to at least one of the base and the lid, and the methods further can comprise grasping the eraser during the erasing without grasping the at least one of the lid and the base. The methods can comprise refilling the ink-containing pad from a refill bottle containing erasable ink.

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts an isometric view of a stamp pad containing erasable ink and tethered to an eraser.

FIG. 2 depicts a schematic representation of a kit containing a rubber stamp pad containing erasable ink, an easily erasable substrate, erasers, a rubber stamp and a refill bottle containing erasable-ink.

FIG. 3 depicts an end plan view of a hinged stamp pad with an eraser adhered atop the lid of the stamp pad.

FIG. 4 depicts a schematic representation of a kit containing a stencil and two types of ink-spray bottles, and a dry-erase board.

FIG. 5 depicts a schematic representation of a goal tracking system.

FIG. 6 depicts a chart of various exemplary goals and steps toward achieving the goals.

### DETAILED DESCRIPTION

The present invention comprises erasable-ink delivery and usage devices, methods, and the like, including rubber stamp pads, spray bottles (aerosol, pump and otherwise), and stencil sets. The delivery and usage devices are useful for any desired purpose, including, for example, the goal tracking system discussed herein, making advertisements, making presentations for meetings, etc. The erasable ink can be wet or dry-erasable-ink. The erasable ink from the delivery device can be applied to and erased from any suitable surface, such as glass or a dry erase board.

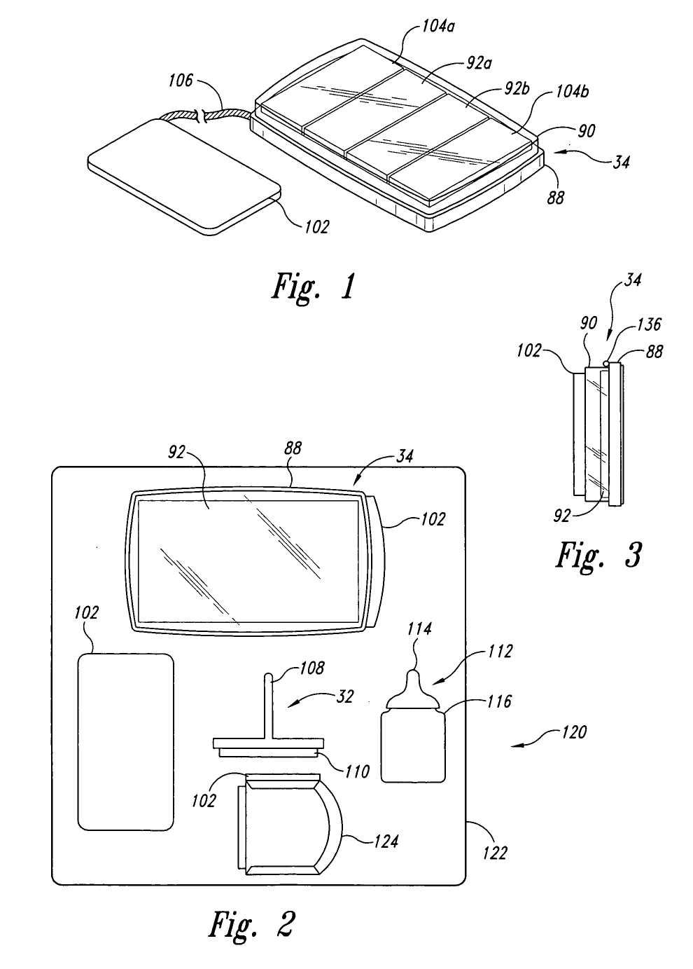

Turning to the Figures, FIG.1 depicts one embodiment of a rubber stamp pad 34 comprising a base 88 a top or lid 90. The base 88 contains two erasable-ink-containing pads, 92a, 92b wherein pad 92a is filled with erasable-ink of a first color while 92b is filled with a dry erase ink of a second, different color or texture. The pad also contains two additional ink-containing pads, 104a, 104b which pads can contain non-erasable inks or erasable-inks as desired. In FIG. 1, the lid is sized to cover the ink-containing pad to protect the pads from inadvertent contact, from exposure to the elements, and from drying out. The lid 90 can be configured otherwise to provide other protections or uses in addition to, or instead of, such protections. In FIG. 1 the lid 90 is fully detachable from the base 88. The lid 90 and base 88 can be connected if desired.

An erasable-ink eraser 102 is linked by a tether 106 to the base 88. The tether 106 can be chain, string, cable, rope, leather, plastic, metal, fabric or any other desired material. Typically, the tether is flexible but if desired can also be rigid. Accordingly, the tether 106 typically provides a flexible, elongated coupler that keeps the eraser 102 and the rubber stamp pad 34 together. Rubber stamp pad 34 can be made of any desirable material, for example metal, plastic, wood, rubber, etc. Similarly, erasable-ink containing pads 92a, 92b can be made of any desired material such as felt, plastic, sponge, polyurethane, etc.

FIG. 2 depicts a kit 120 comprising a rubber stamp pad 34, an erasable-ink eraser 102 (both in non-attached and attached format), a rubber stamp 32, a self-inking rubber stamp 124, and a refill bottle 112. In the embodiment depicted in FIG. 2, a single erasable-ink-containing pad 92 is disposed on the base 88 of rubber stamp 34 and an erasable-ink eraser 102 is adhered directly to the side of base 88. Adhered includes, for example, glued, pasted, velcroed, magnetized, suctioned. If desired, the erasable-ink easer 102 can be adhered or otherwise attached at any location of the rubber stamp pad 34, including the top, sides, bottom, corners, hinges (if any), etc. Kit 120 can also comprise a substantially flat easily erasable substrate 122, which as depicted is a dry erase board although any desirable substrate, such as a magnet with an erasable (e.g., dry-erasable) surface, of any desired shape can be included. Such substrate can include other markings if desired, including permanent markings; exemplary substrates are discussed further elsewhere herein. The easily erasable substrate 122 in the kit in FIG. 2 also acts as a backing suitable for use with a bubble pack (bubble not shown). Any other suitable container can also be used, such as a box, a carton, a bag, a bottle, a rack or any other suitable device.

In the embodiment in FIG. 2, a non-attached erasable-ink eraser 102 is also provided. Additionally provided is a rubber stamp 32 comprising a handle 108 and a stamping element 110. “Rubber stamp” is used herein to indicate any stamping device, and therefore it can be made of rubber, plastic, wood, metal or any other suitable composition. The rubber stamp can be self-inking if desired, as exemplified by self-inking rubber stamp 124. In such embodiments, the rubber stamp pad is typically incorporated into the stamp, along with a handle and, if desired, linkages connecting the various components of the self-inking stamp. The erasable-ink eraser can be attached to any desired part of the self-inking stamp 124 to be attached to the stamp pad system.

The kit additionally contains a refill bottle 112 comprising a cap 114 and a body 166. The refill bottle is configured to deliver the erasable-ink to erasable-ink-containing pad 92 when such pad is low on ink. In certain embodiments of the present invention, such a refill bottle, including any labeling or any other identification associated therewith (for example adhered to the bottle or to packaging containing the bottle) informing or instructing the identity or use of the bottle as an erasable-ink stamp pad refill bottle, is itself an aspect of the present invention, whether included with the remainder of the kit or on its own.

FIG. 3 depicts another view of a rubber stamp pad 34 wherein a hinge connects lid 90 to base 88. In FIG. 3, erasable-ink eraser 102 is adhered directly to the top surface of the lid 90. As noted previously, erasable-ink eraser 102 can be adhered or otherwise attached to the top, the hinge (which as depicted forms a part of each of the lid 90 and the base 88), etc.

Erasable inks suitable for use with the present invention include any desired erasable-ink that satisfies a given manufacturer's or user's needs or desires. In one embodiment, the erasable-ink is a dry erase ink. The erasable ink can also be dry. The ink can be black, blue, red or any other color or combination of colors.

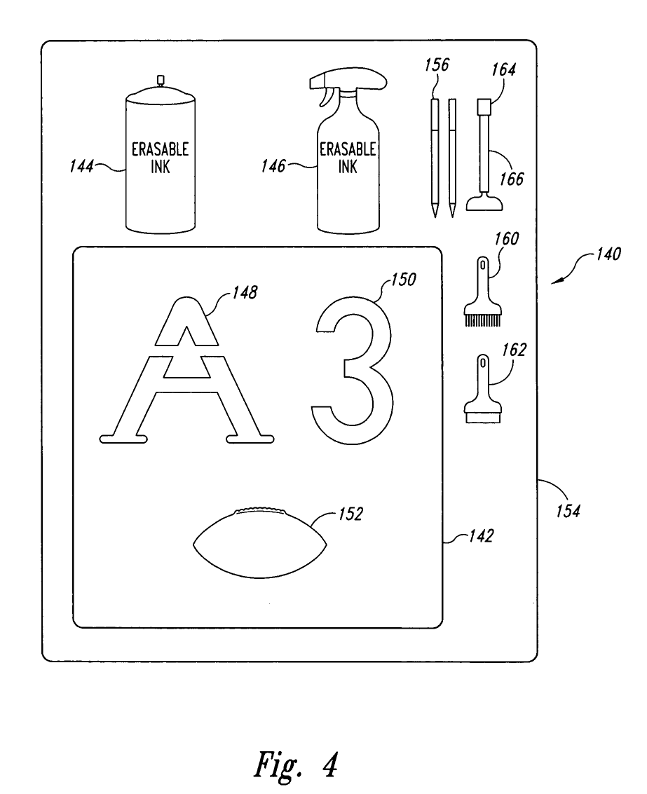

FIG. 4 depicts one embodiment of a stencil set kit 140 comprising a stencil 142, and an aerosol can 144 comprising erasable ink, and a pump-type spray bottle 146 also comprising erasable ink. Other delivery devices, such other ink-spray containers, roller ball pens 156, brushes 160, foam applicators 162, very-wide blade markers 164 (i.e., markers where the writing surface of the blade is at least about 1″), regular markers, etc., can also be used with the stencil or otherwise to apply the erasable ink, which can be a dry erase ink, to a suitable substrate such as dry erase board or a window. In some embodiments, the dry-ink reservoir in a given delivery device, such as the reservoir (not visible) contained within handle 166 of wide blade marker 164, or in conjunction with or as a part of the roller ball pens, brushes, foam applicators, is configured to be squeezable, such squeezing forcing the erasable ink out of the reservoir to the delivery surface. Further, the stencil can comprise symbols such as letter 148, numbers 150 or sports symbol (football) 152. Other symbols, such as logos, artwork, etc., can also be provided. If desired, the kit can be backed by a dry erase board 154 or other suitable erasable substrate, and can also include an eraser such as those discussed elsewhere herein.

The various delivery devices, with or without the stencil, can be used not only to draw figures but to convey textual information such as names and business hours, but also numerical information such as the location of or prices at a restaurant.

In other embodiments, the methods comprise making a stencil kit comprising placing in a single container a stencil and an erasable ink delivery device. The methods can further comprise including an erasable-ink eraser and an easily-erasable substrate. The erasable ink delivery device can be an ink-spray container configured to emit the erasable ink as a spray, such as an aerosol can or pump spray bottle. The erasable ink can be a dry erase ink. Other methods comprise making an erasable ink delivery device such as an ink-spray container comprising placing by pouring or otherwise an erasable ink into the erasable ink delivery device such as the ink-spray container.

The methods also comprise making an erasable ink symbol such as an image, text message, artwork, etc., by applying the erasable ink onto an easily erasable substrate using an erasable ink delivery device as discussed herein. Thus, the erasable ink can be applied by spraying the ink from an aerosol can or a pump spray bottle, by brushing or stamping, or otherwise as desired.

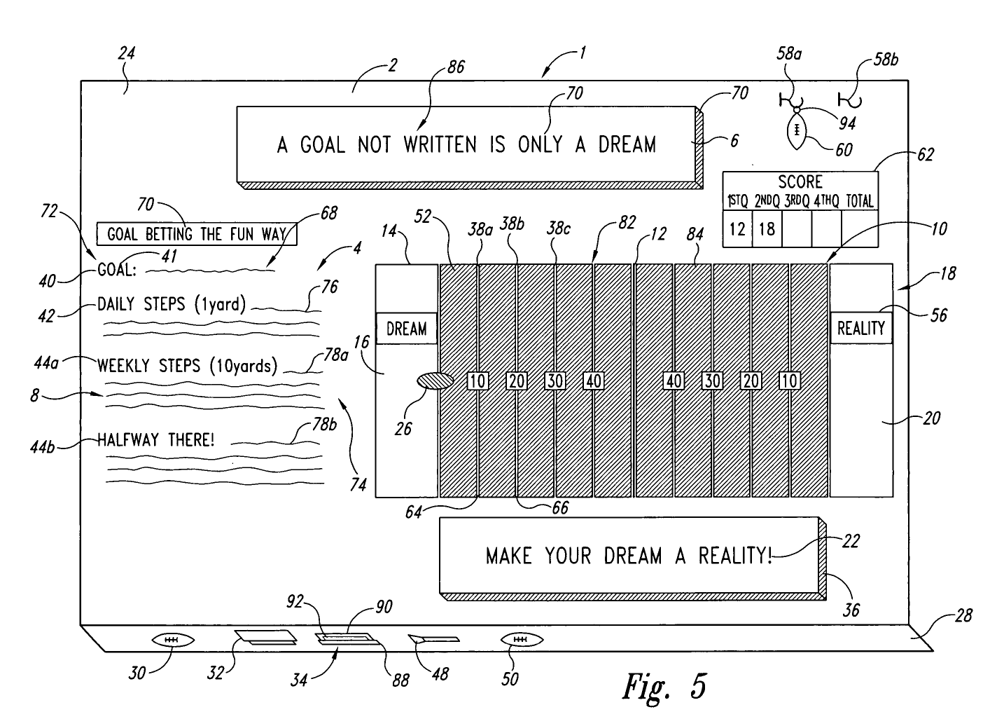

FIG. 5 depicts one embodiment of a goal tracking system 1 comprising a substrate 2. The substrate 2 has a front 24 and a back, and comprises a plurality of defined areas. The substrate can be a board made of wood, metal, plastic, dry erase material, magnetic material, hook-and-loop fastening type material such as Velcro®, cloth, or even a computer screen if desired. The substrate is typically substantially planar, for example rectangular, but can also be cubical, triangular, pyramidal, spherical, or otherwise shaped as desired. The various areas on the substrate are typically separate, but can, if desired, overlap, abut, etc. In certain environments, for example on a computer screen, if desired the defined areas can be clicked and moved as a whole from one location on the substrate to another.

The goal tracking system 1 comprises a title area 6. As depicted, the title area 6 is centrally located toward the upper edge of substrate 2, but can be located in other positions if desired. The title area comprises permanent markings 70. Such markings can be provided via writing with a permanent marker, paint, decals, stitching, fabric, dye, or lines on a computer screen implemented by hardware or software prior to adjustment or writing by a user. As with other areas discussed herein, the specific configuration of the markings includes words identifying the area. Whether the markings include a box around the written statement as depicted in FIG. 5 or solely provide the written statement, or provide other features, can be modified as desired by a user. The title area 6 includes a title 86 that identifies the system as a goal tracking system. As depicted, the title is “A goal not written is only a dream.” Positive and instructional titles such as the title depicted can be preferred because they both suggest positive action to a user while also providing some guidance to the user (here, writing the goal in the goal tracking system).

The goal tracking system 1 further comprises both a goal statement area 4 and an activity area 10. The goal statement area 4 comprises permanent markings that identify the goal statement area. The goal statement area additionally comprises at least one goal statement surface 74 that is configured to removably retain easily removable goal statement symbols. Such configuration can be provided, for example, by a white board or dry erase board, a magnetic board, a magnetic dry erase board, a chalkboard, a user-variable section of a designated portion of a computer screen, etc. The goal statement symbols are typically provided by writing, for example, via a dry erase pen or by typing on a keyboard. The goal statement area 4 comprises a substantially modifiable, rewriteable surface 8 which can be blank, or have lines or a grid or other permanent markings indicating the location of the area and possibly guiding the writing of the goal.

The goal statement area typically comprises a goal statement 40 comprising a “goal” word equivalent (the word “goal” or any other word of equivalent meaning such as a synonym of goal, for example “result, objective, ambition, purpose, target, object, or aspiration). The goal statement area typically additionally comprises one or more short term steps 42 (or “short term” step word equivalent), which as depicted are identified as “daily steps” and are worth one yard on the football field depicted on athletic activity area 10. Goal statement area 4 typically also comprises one or more mid-level goals (or mid-level work equivalence), which as depicted are mid-level terms 44A, 44B “with weekly steps, which are worth ten yards, and half way there which indicates when the user is one half of the way to his or her goal.” Goal statement area 4 further comprises a goal statement area 72 comprising a goal statement surface 74 on which can be provided a goal discussion 46. As noted elsewhere, goal discussion 46 can be implemented via the use of an erasable marker 48 such as a dry erase marker. “Erasable marker” indicates a felt tip marking pen, a ballpoint-marking pen, pencil or any other suitable marking device or writing device, provided that it is has the indicated qualities. The goal word equivalent 41 is provided in conjunction with a goal writing area 68, the short term word equivalent 42 is provided in conjunction with a short term writing area 76, and the mid-level word equivalent is provided with at mid-level writing area 78A, 78B.

The writing, which is typically erasable writing, used to identify and discuss the goal in the goal statement area 4 typically defines a correlation between at least one of the steps recited to attain the goal and movement of the movable activity symbol 26. Accordingly, attaining the goal moves the activity symbol between a first, lower value location 64 on the sports activity field 12 and a second, higher value location 66 on the sports activity field 12. The movable activity symbol 26 can be moved from the lower to higher area or from the higher to lower area. In addition, since each area is typically relative, the higher area can become a lower area once the symbol is moved to that area. The movable activity symbol 26 can be applied to the sports activity field 12 via any desired approach including continuously movable devices such as magnets, Velcro-backed pieces, and zippers as well as discretely movable devices such as stampings, releasable adhesives, snaps, clips, and pins (some devices can be both or either discretely or continuously movable), or any other desired modality.

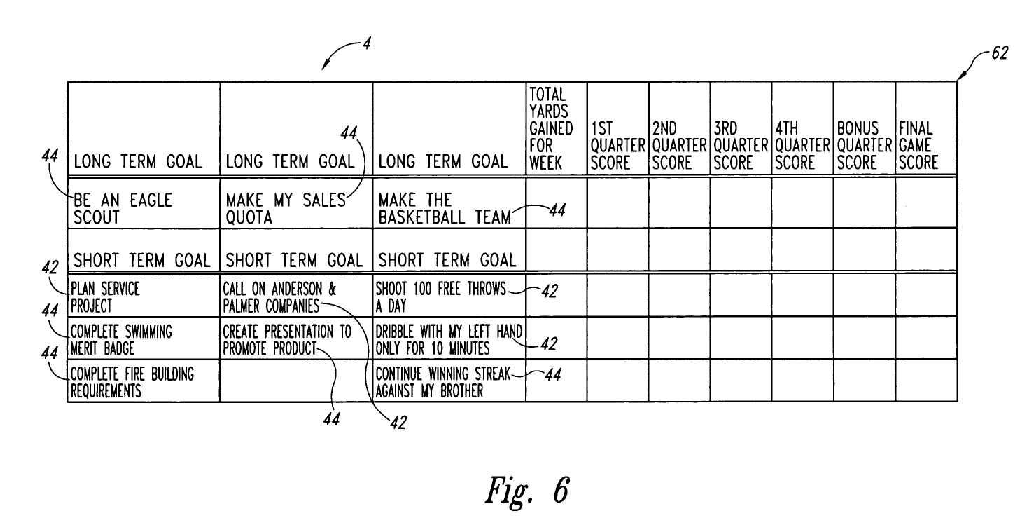

FIG. 6 depicts some exemplary goal statements 40 and some short term steps 42 and mid-level steps 44 toward achieving the goals. As depicted, the goal statements 40 include becoming an eagle scout, making a sales quota and making a basketball team. Short-term steps 42 and mid-level steps 44 include planning a service project, completing a swimming merit badge completing fire building requirements, calling on a customer, creating a sales presentation, shooting free throws, practicing dribbling with one's left hand, and playing and beating a particular opponent.

Returning to FIG. 5, activity area 10 comprises at least one sports activity field 12. In turn, sports activity field 12 comprises at least one sports activity surface configured to removably retain at least one easily movable activity symbol 26, which as depicted is a football. As depicted, sports activity field 12 is a football field and progresses from left to right, from a dream area 14 (or word equivalent) to a reality area 18 (or word equivalent). “Sports activity field” indicates any sports activity location, for example a tennis court, swimming pool, racetrack, hockey rink, etc. The dream area 14 is located in the first end zone 16 and reality area 18 is located in a second end zone 20. The sports activity field 12 further comprises a plurality of yard lines 38a, 38b, 38c, including, if desired, single yard markers 52. 5-yard and 10-yard markers, or other desired distances, can also be used. The sports activity field 12 can comprise an erasable substrate which provides for erasable writing thereon, or other suitable substrates as desired. In FIG. 5, sports activity field 12 comprises an erasable surface 82 for one half of the field and a felt surface 84 suitable for use with a Velcro-containing movable symbol for the other half. Accordingly, the sports activity field 12 provides for lower value and higher value locations. In the embodiment depicted the lower value location 64 is closer to the dream are 14, while the higher value location 66 is closer to the reality value location 18.

The substrate 2 can also contain a positive slogan 22 disposed in a positive slogan area 36. As depicted, the positive slogan states “Make Your Dream a Reality!” The positive slogan area 36 can, similar to other areas discussed herein such as title area 6, be provided with a variety of markings, including positive slogan 22, lines or other markings as desired. Scorekeeping area 62 comprises at least one score keeping surface configured to removably retain score keeping symbols. As depicted, the scorekeeping area 62 is divided into four quarters and a total to provide five spaces for keeping a running tally of the score. The scorekeeping area 62 can be configured as desired for a given goal or for a given sport. Typically, scorekeeping area 62 is enclosed by permanent markings, as with certain other areas discussed herein.

The goal tracking system 1 can, if desired, additionally comprise a tray 28 or hooks 58a, 58b configured to retain one or more writing implements, movable symbols and the like. Such tray 28 and hooks 58a, 58b are exemplary of a holder configured to hold at least one of a movable device and a movable symbol or other items as desired. For example, suitable symbols include a supplemental movable symbol such as second football 30, which football on one side comprises either a male side or a female side of a hook-and-loop fastening type material such as Velcro (in which case the sports activity field would typically comprise the corresponding side of the hook-and-loop type fastening material.) Tray 28 additionally holds rubber stamp 32 and rubber stamp pad 34. Rubber stamp 34 can be made of any desired material, such as rubber, wood cut, plastic, etc. Tray 28 additionally holds an erasable marker 48 and a magnetic football 50, while hook 58a holds a movable symbol 60 dangling from a toroidal snap 94. An easily movable activity symbol is a symbol that can be moved without significant effort, for example, via sliding as with a magnet, or by removing and replacing as with a stamped figure, Velcro piece or magnet, or by clicking and dragging as with a computer icon.

The rubber stamp pad 34 comprises a base 88, a top 90 (shown in open position), and an ink-containing pad 92. In certain embodiments, the rubber stamp pad 34, including the ink-containing pad 92 therein, are filled with an erasable ink, such as a dry erase ink. Such a stamp pad can be used for any desired purpose relating to the application of erasable ink, such as the application of such ink to a dry erase board or other erasable surface, etc. Accordingly, the apparatus and methods, etc., discussed herein include the erasable stamp pad discussed herein including for purposes other than the goal tracking systems, etc., herein.

If desired, the goal tracking system 1 can be combined with one or more of the movable symbols 26 in a kit. Such a kit may or may not be provided in a single container as desired. If desired, the goal tracking system 1, with or without the movable symbol, can additionally comprise a kit comprising the goal tracking system 1 and at least one erasable marker 48.

Turning to some methods, Turning to some methods, the methods include making a stamp pad sized and configured to provide ink to a rubber stamp, comprising providing a stamp pad comprising a base and a lid, and attaching an ink-containing pad containing substantially only erasable ink to the base. The methods can also comprise attaching to at least one of the base and the lid an erasable-ink eraser configured to remove the erasable ink from a surface. The erasable-ink eraser can be tethered, directly adhered or otherwise attached as desired. The ink-containing pad containing substantially only erasable ink can be disposed next to (e.g., abutting, close to, divided by a membrane, etc.) a second ink-containing pad on the base.

The methods also include making a stamp pad kit, comprising placing a stamp pad comprising an erasable-ink eraser as discussed herein in a single container. The methods can also comprise adhering or otherwise attaching the erasable-ink eraser directly to the at least one of the base and the lid, or providing the erasable-ink eraser unattached to either the base or the lid.

The methods further can comprise placing a refill bottle in the container, the refill bottle containing erasable ink and the bottle configured for re-filling the ink-containing pad. At least one rubber stamp sized for use with the ink-containing pad can also be placed in the container. An easily erasable substrate can also be placed in the container; such substrate (as with certain other elements discussed herein) can form a part of the container if desired.

In other aspects, the methods can comprising stamping using a stamp pad as discussed herein, the methods comprising applying a rubber stamp inked with an erasable ink to a surface to transfer the erasable ink from the rubber stamp to the surface; and erasing the erasable ink from the surface with an erasable-ink eraser. The methods can also comprise, before applying the rubber stamp to the surface, inking the rubber stamp by applying the rubber stamp to the erasable ink-containing pad such that the erasable ink is transferred from the ink-containing pad to the rubber stamp.

Where the eraser is adhered directly to the lid or the base, the methods can also comprise grasping the lid or base (or both) and then erasing by applying force to the eraser through the lid or base. Where the eraser is linked by a tether to the base or the lid, the methods can comprise grasping the eraser during the erasing without grasping the base or the lid. The methods can also comprise refilling the ink-containing pad from a refill bottle containing erasable ink.

The methods relating to the goal tracking system include manufacturing the goal tracking system 1 by applying appropriate markings to a suitable substrate in such relation to each other to provide the devices and systems discussed herein. In addition, methods of manufacturing can comprise combining such systems with one or more suitable movable symbols, or an erasable marker 48 or other desired writing device. Such movable symbols typically depict players, playing equipment (such as balls, bats, sticks, etc.) and the like that are specifically correlated to the sport depicted in the sports activity field.

Other methods include methods of playing, implementing or otherwise using the systems and kits, etc., discussed herein. For example, a method of goal tracking can comprise providing a goal statement on an identified goal statement area comprising at least one goal statement surface that is configured to removably retain an easily removable goal statement symbol. The goal statement area can comprise a part of a goal tracking system as discussed herein comprising at least one title area, the goal statement area and at least one identified sports activity field comprising at least one sports activity surface that is also configured to removable retain at least one easily movable activity symbol. Next, the methods can comprise writing at least one step for achieving the goal in the goal statement area. The writing defines a correlation between the step and moving the movable activity symbol between a first, lower value location on the sports activity field and a second, higher value location on a sports activity field, the movement thereby indicating progress (including negative progress) relative to the ultimate goal. The method typically further comprises moving the sports activity symbol about the sports activity field in accordance with the achievement (including the lack thereof) of the steps.

Typically, the methods further comprise writing at least on “short term” word equivalent in a short term writing area, defining at least one short-term step thereby. Further, the method typically comprises writing at least one “mid-level” word equivalent in the mid-level area and defining at least one mid-level step thereby. Typically the writing is erasable writing, for example via an erasable marker or keyboarding.

The method can further comprise keeping score of the progress in at least one scorekeeping area on the surface of the system, the scorekeeping area comprising substantially permanent markings that identify the scorekeeping area. In certain embodiments, the sports activity area can be a football field and the method can further comprise moving a football symbol along the field. The yards can be attained or lost in correlation to successful, or unsuccessful completion of at least one of the steps.

For example, the football symbol can initially be placed at a first goal line associated with a “dream” word equivalent end zone. The football can then be moved after a defined time period wherein the amount and direction of movement of the football symbol is determined according to the degree of completion of the step(s) during the defined time period. The time period can be any desired time, for example a day, a week, a month, or even an hour or a year. As discussed elsewhere herein, the sports activity area can comprise any of a variety of desired substrates, and the sports activity symbol can comprise any of a variety of corresponding devices. For example, the sports activity area can comprise an erasable substrate while the sports activity symbol comprises dry erase ink applied via a rubber stamp or other desired device. Moving the sports activity symbol can then comprise erasing the first applied symbol and then reapplying the dry erase ink to a second location to provide a second applied symbol (if desired, the applied symbols can be applied intact). Similarly, the sports activity area can comprise at least one of the male or female sides of a Velcro-type fastening system, with the sports activity symbol comprising the corresponding side. Moving the sports activity symbol can then comprise attaching the sports activity symbol to a first location and then removing the symbol and then reapplying it to a second location. Moving be also implemented with magnetic boards-magnetic sports activity symbols, and with computer screens-drag and clicking computer generated icons or otherwise as desired.

In another approach, the methods can comprise writing the goal on an erasable goal identified goal statement area of a goal tracking system, which goal tracking system may not comprise a title area, the surface of the goal tracking system comprising a sports activity area as discussed herein. In such a situation, the goal should comprise an end result other than merely playing the game depicted in the given field for the sporting event. For example, using a football field-based system, the goal, as depicted in FIG. 6, could be becoming an eagle scout, making a sales quota or making a basketball team. If the long-term goal is to be an eagle scout then short-term and mid-level steps can include planning a service project, completing a swimming merit badge and completing fire building requirements. If the long-term goal is to make a sales quota, then the short-term goal can be calling on a given company and a mid-level goal can be creating a presentation to promote the product to be sold. Similarly, if the ultimate goal is to make the basketball team, then the short-term goals can be to shoot 100 free throws a day and to practice dribbling with one's left hand for 10 minutes a day, and a mid-level or intermediate goal can be to continue a playing and beating particular opponent.

The progress of the goals can be kept on the scorekeeping area. Briefly, scorekeeping area includes columns for total yards gained for a given week, quarterly scores for the 4 given quarters, a bonus quarter score if desired (for example, for unusually good performance within one of the quarters or to provide a fifth recording period where desired), and a final game score which, hopefully, will be attaining all 100 yards and a touchdown in the “reality” end zone.

For computer-based implementations of the systems and methods, etc., herein, such can be implemented on a single computer such as a personal computer or a laptop computer, over an intranet or internet, in groups or individually or otherwise as desired. Further, there can be a host or manager that can access each participant's progress for tracking, monitoring, or other passive or interactive purpose (participants can likewise be selectively permitted to view each other's progress or be blocked from seeing each other's progress, or intermediate variations thereof where some persons can view some other's progress, but not all, etc.). Further, there can be at least one functionality button associated with a given screen, which can permit multiple viewings, manipulation of data, goals, etc., by the manager or host or other person as desired, the ability to modify specific themes (such as whether the goal-oriented activity is a football game, a track meet, climbing a mountain, or changing the value of given goal, for example increasing mountain height from 2,000 feet elevation to 3,000 feet elevation, or adding or deleting mileposts along the way), and the like. Thus, the systems can be interactively updated, modified, amended, etc., to provide positive reinforcement or other purposes.

If desired, the systems can further comprise using a photograph or other specific representation of a participant or user. This can be, for example, an actual paper photograph with hard-version game boards such as dry erase boards, or digital photos for use with computer-implemented systems.

The preceding paragraphs provide definitions of some of the terms used herein. All terms used herein are used in accordance with their ordinary meanings unless the context or definition clearly indicates otherwise. Also unless indicated otherwise, except within the claims, the use of “or” includes “and” and vice-versa. Nonlimiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present systems and methods, etc., includes both means plus function and step plus function concepts. However, the terms set forth in this application are not to be interpreted in the claims as indicating a “means plus function” relationship unless the word “means” is specifically recited in a claim, and are to be interpreted in the claims as indicating a “means plus function” relationship where the word “means” is specifically recited in a claim. Similarly, the terms set forth in this application are not to be interpreted in method or process claims as indicating a “step plus function” relationship unless the word “step” is specifically recited in the claims, and are to be interpreted in the claims as indicating a “step plus function” relationship where the word “step” is specifically recited in a claim. “Step” as discussed in this paragraph regarding “step plus function” is to be distinguished from the usage of “step” herein when discussing the steps to be taken to attain a goal.

From the foregoing, it will be appreciated that, although specific embodiments have been discussed herein for purposes of illustration, various modifications may be made without deviating from the spirit and scope of the disclosure. Accordingly, the systems and methods, etc., include such modifications as well as all permutations and combinations of the subject matter set forth herein and is not limited except as by the appended claims.

What is claimed is:

1. A stamp pad kit comprising:
a stamp pad sized and configured to provide ink to a rubber stamp, the stamp pad comprising a base and an ink-containing pad containing substantially only erasable ink, a lid sized to cover the ink-containing pad; and an erasable-ink eraser configured to remove the erasable ink from a surface.

2. The stamp pad kit of claim 1 wherein the eraser is attached to at least one of the base and the lid.

3. The stamp pad kit of claim 2 wherein the eraser is adhered directly to a top surface of the lid.

4. The stamp pad kit of claim 2 wherein the eraser is linked by a tether to at least one of the base and the lid.

5. The stamp pad kit of claim 1 wherein the eraser is not attached to either the base or the lid.

6. The stamp pad kit of claim 1 wherein the ink-containing pad containing substantially only erasable ink is disposed next to a second ink-containing pad on the base.

7. The stamp pad kit of claim 1 wherein the erasable ink is a dry erase ink.

8. The stamp pad kit of claim 1 wherein the kit further comprises at least one rubber stamp sized for use with the ink-containing pad.

9. The stamp pad kit of claim 1 wherein the kit further comprises a refill bottle containing erasable ink, the bottle configured for re-filling the ink-containing pad.

10. The stamp pad kit of claim 7 wherein the kit further comprises a refill bottle containing dry erase ink, the bottle configured for re-filling the ink-containing pad.

11. The stamp pad kit of claim 1 wherein the kit further comprises an easily-erasable substrate.

12. The stamp pad kit of claim 7 wherein the kit further comprises a dry erase board.

13. The stamp pad kit of claim 1 wherein the kit further comprises a self-inking stamp pad.

14. The stamp pad kit of claim 7 wherein the kit further comprises a self-inking stamp pad.

15. A self-inking rubber stamp comprising a stamp pad sized and configured to provide ink to a rubber stamp, wherein the improvement comprises the stamp pad comprising substantially only erasable ink.

16. The self-inking rubber stamp of claim 15 wherein the self-inking rubber stamp further comprises an erasable-ink eraser configured to remove the erasable ink from a surface.

17. The self-inking rubber stamp of claim 16 wherein the eraser is adhered directly to a side of the self-inking rubber stamp.

18. The self-inking rubber stamp of claim 16 wherein the eraser is linked by a tether to the self-inking rubber stamp.

19. The self-inking rubber stamp of claim 15 wherein the ink-containing pad containing substantially only erasable ink is disposed next to a second ink-containing pad on the base.

20. The self-inking rubber stamp of claim 15 wherein the erasable ink is a dry erase ink.

21. A base for a stamp pad sized and configured to provide ink to a rubber stamp, the base holding an ink-containing pad containing substantially only erasable ink disposed on the base and attached to an erasable-ink eraser configured to remove the erasable ink from a surface.

22. The base of claim 21 wherein the eraser is adhered directly to at least one of a side surface and a bottom surface of the base.

23. The base of claim 21 wherein the eraser is linked by a tether to the base.

24. The base of claim 21 wherein the ink-containing pad containing substantially only erasable ink is disposed next to a second ink-containing pad on the base.

25. The base of claim 21 wherein the erasable ink is a dry erase ink.

26. A lid for a stamp pad, the lid sized to cover an ink-containing pad on the stamp pad and the lid attached to an erasable-ink eraser configured to remove the erasable ink from a surface.

27. The lid of claim 26 wherein the eraser is adhered directly to at least one of a top surface and a side surface of the lid.

28. The lid of claim 26 wherein the eraser is linked by a tether to the lid.

29. The lid of claim 26 wherein the eraser is configured for erasing dry erase ink.

30. A method of making a stamp pad sized and configured to provide ink to a rubber stamp, the method comprising providing a stamp pad comprising a base and a lid, and attaching an ink-containing pad containing substantially only erasable ink to the base.

31. The method of claim 30 wherein the method further comprises attaching to at least one of the base and the lid an erasable-ink eraser configured to remove the erasable ink from a surface.

32. The method of claim 30 wherein the method further comprises adhering the erasable-ink eraser directly to the at least one of the base and the lid.

33. The method of claim 30 wherein the method further comprises linking the erasable-ink eraser to the at least one of the base and the lid via a tether.

34. The method of claim 30 wherein the ink-containing pad containing substantially only erasable ink is disposed next to a second ink-containing pad on the base.

35. The method of claim 30 wherein the erasable ink is a dry erase ink.

36. A method of making a stamp pad kit comprising:
placing in a single container a stamp pad sized and configured to provide ink to a rubber stamp, the stamp pad comprising a base and an ink-containing pad containing substantially only erasable ink, a lid sized to cover the ink-containing pad and an erasable-ink eraser configured to remove the erasable ink from a surface.

37. The method of claim 36 wherein the method further comprises adhering the erasable-ink eraser directly to the at least one of the base and the lid.

38. The method of claim 36 wherein the method further comprises linking the erasable-ink eraser to the at least one of the base and the lid via a tether.

39. The method of claim 36 wherein the erasable-ink eraser is not attached to either the base or the lid.

40. The method of claim 36 wherein the ink-containing pad containing substantially only erasable ink is disposed next to a second ink-containing pad on the base.

41. The method of claim 36 wherein the erasable ink is a dry erase ink.

42. The method of claim 36 wherein the method further comprises placing in the container a refill bottle containing erasable ink, the bottle configured for re-filling the ink-containing pad.

43. The method of claim 42 wherein the method further comprises placing in the container a refill bottle containing dry erase ink, the bottle configured for re-filling the ink-containing pad.

44. The method of claim 36 wherein the method further comprises placing in the container at least one rubber stamp sized for use with the ink-containing pad.

45. The method of claim 36 wherein the at least one rubber stamp is a self-inking rubber stamp containing the stamp pad.

46. The stamp pad kit of claim 36 wherein the method further comprises providing at least one easily-erasable substrate with the kit.

47. A method of stamping using a stamp pad comprising:
applying a rubber stamp inked with an erasable ink to a surface to transfer the erasable ink from the rubber stamp to the surface; and
erasing the erasable ink from the surface with an erasable-ink eraser.

48. The method of claim 47 wherein the method further comprises, before applying the rubber stamp to the surface, inking the rubber stamp by applying the rubber stamp to an ink-containing pad containing substantially only erasable ink such that the erasable ink is transferred from the ink-containing pad to the rubber stamp.

49. The method of claim 47 or 48 wherein the method is performed using a self-inking rubber stamp.

50. The method of claim 47 wherein the erasable-ink eraser is attached to at least one of a base comprising the ink-containing pad and a lid sized to cover the ink-containing pad.

51. The method of claim 50 wherein the eraser is adhered directly to at least one of the lid and the base and the method further comprises grasping the at least one of the lid and the base and during erasing applying force to the eraser through the at least one of the lid and the base.

52. The method of claim 50 wherein the eraser is linked by a tether to at least one of the base and the lid, and the method further comprises grasping the eraser during the erasing without grasping the at least one of the lid and the base.

53. The method of claim 47 wherein the erasable ink is a dry erase ink.

54. The method of claim 47 wherein the method further comprises refilling the ink-containing pad from a refill bottle containing erasable ink.

55. The method of claim 54 wherein the kit further comprises a refill bottle containing dry erase ink, the bottle configured for re-filling the ink-containing pad.

56. A stencil kit comprising a stencil and an erasable ink delivery device.

57. The stencil kit of claim 56 wherein the kit further comprises an erasable-ink eraser configured to remove the erasable ink from a surface.

58. The stencil kit of claim 56 wherein the kit further comprises an easily-erasable substrate.

59. The stencil kit of claim 57 wherein the eraser is attached to at least one of the stencil and the substrate.

60. The stencil kit of claim 57 wherein the eraser is linked by a tether to at least one of the stencil and the substrate.

61. The stencil kit of claim 56 wherein the eraser is not attached to either the stencil or the substrate.

62. The stencil kit of claim 57 wherein the erasable ink is a dry erase ink.

63. The stencil kit of claim 56 wherein the erasable ink delivery device is an ink-spray container configured to emit the erasable ink as a spray.

64. The stencil kit of claim 56 wherein the ink-spray container is an aerosol can or a pump spray bottle.

65. The stencil kit of claim 63 wherein the kit further comprises a refill bottle containing dry erase ink, the bottle configured for re-filling the ink-spray container.

66. An ink-spray container containing an erasable ink and configured to emit the erasable ink as a spray.

67. The ink-spray container of claim 66 wherein the erasable ink delivery device is an aerosol can.

68. The ink-spray container of claim 66 wherein the ink-spray container is a pump spray bottle.

69. A method of making a stencil kit comprising placing in a single container a stencil and an erasable ink delivery device.

70. The method of claim 69 wherein the method further comprises placing in the container an erasable-ink eraser configured to remove the erasable ink from a surface.

71. The method of claim 69 wherein the method further comprises placing in the container an easily-erasable substrate.

72. The method of claim 69 wherein the erasable ink delivery device is an ink-spray container configured to emit the erasable ink as a spray.

73. The method of claim 69 wherein the erasable ink is a dry erase ink.

74. A method of making an ink-spray container comprising placing an erasable ink in the ink-spray container.

75. The method of claim 74 wherein the erasable ink delivery device is an aerosol can.

76. The method of claim 74 wherein the ink-spray container is a pump spray bottle.

77. The method of claim 74 wherein the erasable ink is a dry erase ink.

78. A method of making an erasable ink symbol comprising applying the erasable ink through a stencil comprising the symbol onto an easily erasable substrate.

79. The method of claim 78 wherein the erasable ink is applied by spraying the ink from an aerosol can.

80. The method of claim 78 wherein the erasable ink is applied by spraying the ink from a pump spray bottle.

81. The method of claim 78 wherein the erasable ink is applied by at least one of brushing and stamping.

82. A method of making an erasable ink symbol comprising spraying the erasable ink onto an easily erasable substrate from an ink-spray container configured to emit the erasable ink as a spray.

83. A method of making an erasable ink symbol comprising brushing the erasable ink onto an easily erasable.

84. A method of making an erasable ink symbol comprising stamping the erasable ink onto an easily erasable.

85. The method of any one of claims 78 to 84 wherein the method further comprises erasing the symbol.
